(19) United States
(12) Patent Application Publication
(10) Pub. No.: US 2016/0325658 A1
(43) Pub. Date: Nov. 10, 2016

(54) ISOFIX Trim Retainer

(71) Applicant: Magna Seating Inc, Aurora (CA)

(72) Inventor: David Hodgson, Windsor (CA)

(21) Appl. No.: 15/149,529

(22) Filed: May 9, 2016

Related U.S. Application Data
(60) Provisional application No. 62/158,168, filed on May 7, 2015.

(51) Int. Cl. B60N 2/58

(52) U.S. Cl. CPC B60N 2/5825

(57) ABSTRACT

An ISOFIX trim retainer for retaining an opening in a trim cover of a seat along an anchor bar adapted to be releasably connected to a clip connector. The trim retainer has a generally flat, planar body portion for encircling the opening in the trim cover. The body portion includes a base portion extending between opposing side portions, a pair of retention tabs projecting inwardly towards facing distal ends and spaced generally parallel to the base portion, and an elongated slot defined between the retention tabs and the base portion adapted for receiving at least a portion of the clip connector therethrough.

### CROSS-REFERENCE TO RELATED APPLICATIONS

This application claims priority to U.S. Provisional Application No. 62/158,168, filed on May 7, 2015 and entitled “ISOFIX Trim Retainer.”

### BACKGROUND OF THE INVENTION

1. Field of the Invention

The present invention relates to a trim retainer for use in a seat assembly of an automotive vehicle for retaining a trim cover with respect to an anchor bar used for securing an ISOFIX child seat to the seat assembly.

2. Description of Related Art

ISOFIX is an international standard for attachment points for securing child safety seats in automotive vehicles. The passenger seats of automotive vehicles include a generally horizontal seat cushion and a generally upright seat back operatively coupled to the seat cushion. The seat also includes a pair of spaced apart U-shaped anchor bars fixedly secured to the frame of the seat and projecting outwardly from either the top surface of the seat cushion or the front surface of the seat back and adjacent to the intersection formed between the seat cushion and the seat back of the seat assembly. The child safety seat includes a corresponding pair of open style clip connectors for releasably attaching to the anchor bars to safely secure the child safety seat to the vehicle seat.

Each of the seat cushion and seat back are formed of a rigid frame for supporting a cellular foam pad encased in a trim cover. The anchor bars typically project outwardly from either the seat cushion frame or the seat back frame and extend through an opening formed in the trim cover for receiving the clip connectors of the child safety seat.

It is commonly known to provide a trim retainer secured to the trim cover for encircling and defining the opening in the trim cover for the anchor bars and to maintain the fit, finish and aesthetics of the trim cover. A commonly used trim retainer is shown in prior art FIGS. 1 and 2 and comprises an elongated plastic trim retainer 10 having a center elongated slot 12 formed therein. The perimeter of the trim retainer 10 is threadedly stitched to the back surface of the trim cover at thread holes 14 to align the slot 12 with the opening formed in the trim cover. The trim retainer 10 assists with maintaining the opening in the trim cover and the anchor bar extends through the slot 12 of the trim retainer 10 and the opening formed by the surrounding trim cover.

Referring to FIG. 2, a clip connector 32 and anchor bar 18 is shown aligned with the slot 12 of the trim retainer 10. However, as shown in FIG. 2, when the clip connector 32 is aligned and inserted for connection with the anchor bar 18, the trim retainer 10 is engaged by the clip connector 32 and must be pressed or flexed inwardly to allow proper access to the anchor bar 18, thus increasing the efforts required to press the clip connector 32 against the trim cover and through the opening to fixedly connect with the anchor bar 18.

Therefore, it is desirable to provide an improved trim retainer for supporting the trim cover around the opening formed therethrough while allowing easy access and proficient connection of the clip connector with the anchor bar to secure the ISOFIX child safety seat to the vehicle seat.

### SUMMARY OF THE INVENTION

According to one aspect of the invention, an ISOFIX trim retainer is provided for retaining an opening in a trim cover of a seat along an anchor bar adapted to be releasably connected to a clip connector. The trim retainer comprises a generally flat, planar body portion for encircling the opening in the trim cover. The body portion includes a base portion extending between opposing side portions, a pair of retention tabs projecting inwardly towards facing distal ends and spaced generally parallel to the base portion, and an elongated slot defined between the retention tabs and the base portion adapted for receiving at least a portion of the clip connector therethrough.

The facing distal ends of the retention tabs form a gap therebetween for allowing each of the retention tabs to flex relative to the rounded ends in a direction generally transverse to the planar body portion. A portion of the clip connector passes through the slot for connection with the anchor bar and another portion of the clip connector flexes the retention tabs inwardly to reduce the effort for connection with the anchor bar.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a front view of a trim retainer as is commonly known in the prior art;

FIG. 2 is a front view of the prior art trim retainer of FIG. 1 attached to an anchor bar for receiving an ISOFIX clip connector;

FIG. 3 is front plan view of a trim cover of a vehicle seat with an anchor bar and ISOFIX trim retainer shown in phantom according to one embodiment of the invention;

FIG. 4 is a fragmentary side view of a clip connector commonly associated with an ISOFIX child safety seat for releasably connecting to the anchor bar;

FIG. 5 is fragmentary rear plan view of the trim cover of FIG. 3 showing the formation of openings therein for receiving the anchor bars;

FIG. 6 is a front view of the ISOFIX trim retainer coupled to the anchor bar;

FIG. 7 is a fragmentary rear plan view of the trim cover with the ISOFIX trim retainer fixedly secured thereto and supporting an opening in the trim cover; and

FIG. 8 is a fragmentary perspective view of the ISOFIX trim retainer fixedly secured to the trim cover.

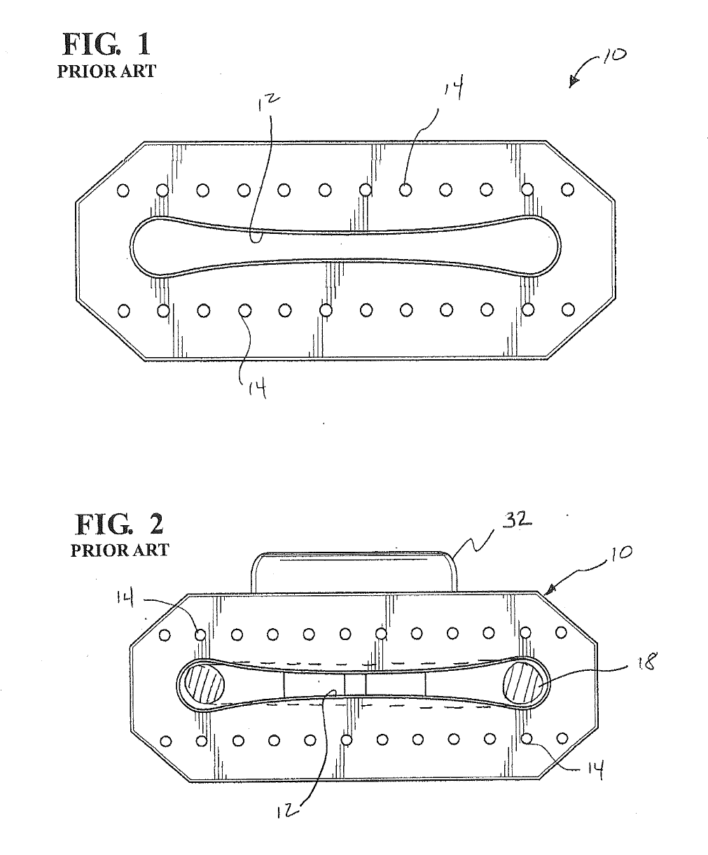

### DETAILED DESCRIPTION OF THE EMBODIMENTS

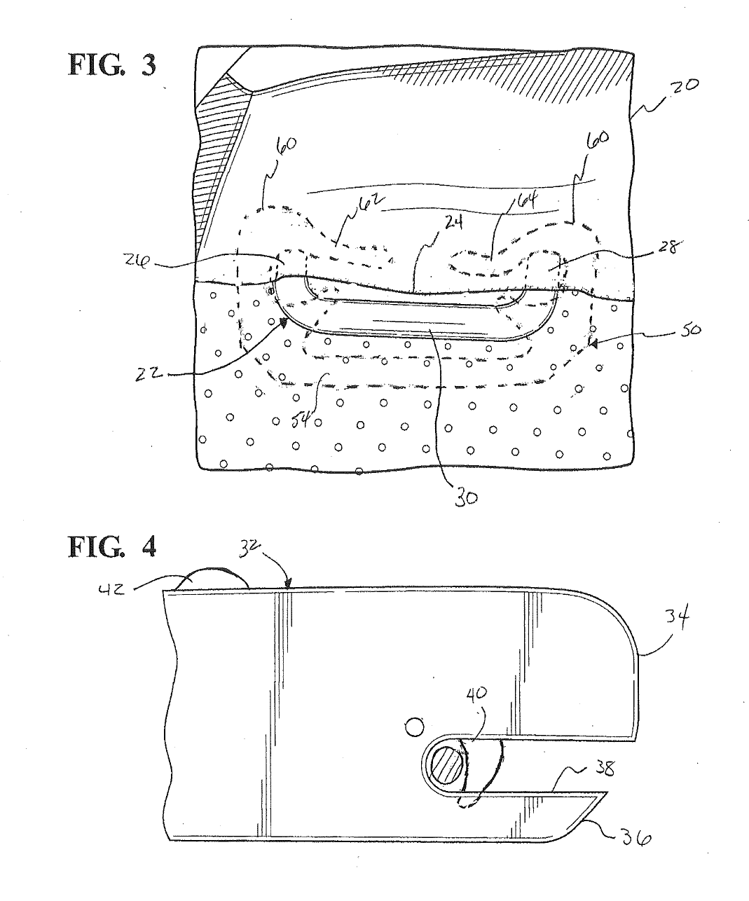

Referring to the Figures, wherein like numerals indicate like or corresponding parts throughout the several views, FIG. 3 shows a trim cover 20 for encasing a cellular foam pad of a seat cushion for an automotive vehicle seat as is commonly known in the art. The trim cover 20 may be comprised of a sheet of cloth, vinyl, leather or a combination thereof and is typically backed with a thin layer of foam scrim. The seat cushion is supported by a rigid metal seat frame structure for supporting a seat occupant in the vehicle seat within an automotive vehicle. A pair (only one shown in FIG. 3) of ISOFIX anchor bars 22 are fixedly secured to the seat frame structure and project through an opening 24 formed in the trim cover 20. The anchor bar 22 is generally U-shaped including parallel and shaped apart side bars 26, 28 and a front cross bar 30 connected between the side bars 26, 28. Referring to FIG. 4, an ISOFIX clip connector 32 is shown as is well known in the art for releasably connecting to each of the pair of anchor bars 22 for safely and securely attaching an ISOFIX child safety seat to the vehicle seat. More specifically, an ISOFIX child safety seat includes a pair of spaced apart clip connectors 32 secured and extending therefrom which may be releasably connected to each of the anchors bars 22 on the vehicle seat to easily and securely connect the child safety seat to the vehicle seat. Each clip connector 32 includes an upper portion 34 and a lower portion 36 forming an elongated notch 38 therebetween for slidably receiving the anchor bar 22 therein. An operable and selectively retractable locking pin or hook 40 extends into the notch 38 from the upper portion 34 to lock and retain the front cross bar 30 of the anchor bar 22 within the notch 38 and secure the clip connector 32 to the anchor bar 22. A release button 42 may be actuated to retract the hook 40 from the notch 38 and allow the clip connector 32 to be released from the anchor bar 22 to remove the child seat from the vehicle seat.

It is desirable to support the material encircling the opening 24 in the trim cover 20 to provide a well-defined and aesthetic appearance around the opening 24 of the trim cover 20 while still facilitating easy connection of the clip connector 32 with the anchor bar 22. The present invention relates to an ISOFIX trim retainer 50, as shown in phantom in FIG. 3, fixedly secured to the underside of the trim cover 22 for supporting the trim cover 22 and further defining the opening 24 therein.

Referring more specifically to FIG. 6, the ISOFIX trim retainer 50 (hereinafter referred to just as the “trim retainer”) includes a plastic or other semi-rigid planar body portion 52 sized sufficiently to surround the opening 24 formed in the trim cover 20. The body portion 52 includes a lower straight base portion 54 having spaced apart side portions 56, 58 extending upwardly from opposite ends thereof to rounded end portions 60. Thin elongated and curved retention tabs 62, 64 extend radially inward from each of the rounded end portions 60. Each tab 62, 64 projects inwardly toward the other to a tear drop shaped distal end 66, 68, respectively which are slightly spaced apart to define a gap 70 therebetween. A slot 72 is formed between an upper edge 73 of the base portion 54 and a bottom edge 75 of each of the tabs 62, 64 for receiving the clip connector 32 there through. A pair of spaced apart retention lobes 74, 76 project radially and angularly upward and inward from the upper edge of the base portion 54 towards each of the respective retention tabs 62, 64. The lobes 74, 76 define opposite ends of the slot 72 with the upper edge 73 of the base portion 54 and also form a pair of generally circular clearance holes 78 with the side portions 56, 58 and bottom edge 75 of the retention tabs 62, 64 for receiving and engaging the side bars 26, 28 of the anchor bar 22. The clearance holes 78 are sized relative to the diameter of the side bars 26, 28 of the anchor bar 22 sufficient to create a slight interference fit therebetween to frictionally retain the trim retainer 50 in the desired position on the anchor bar 22. Additionally, the width of the slot 72 is sized with respect to the width of the clip connector 32 sufficient to allow clearance of the clip connector 32 through the slot 72 in the trim retainer 50.

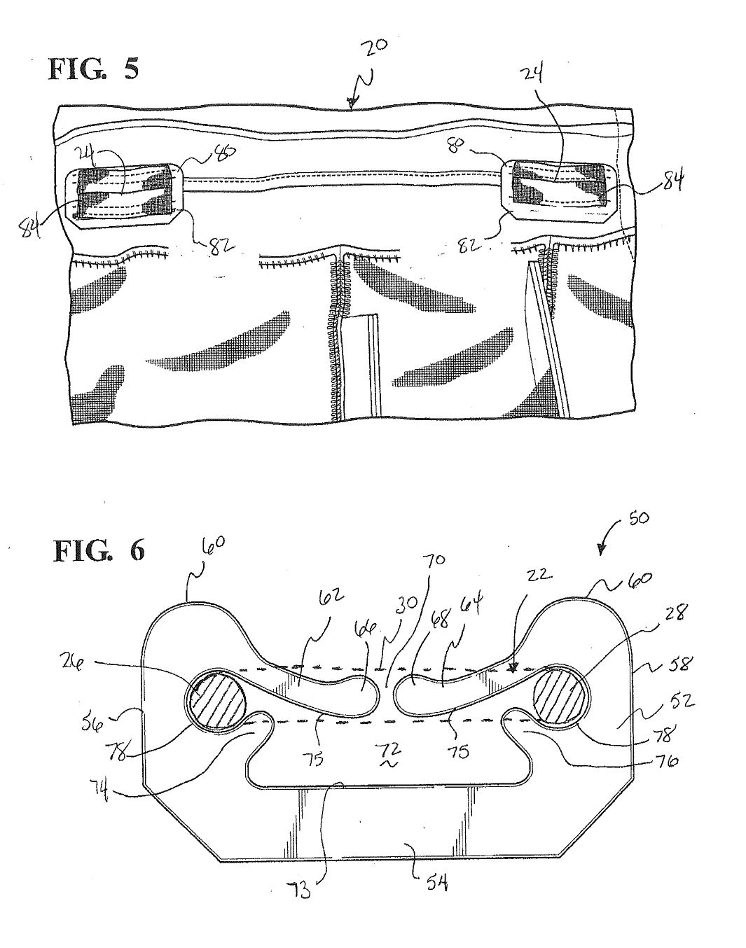

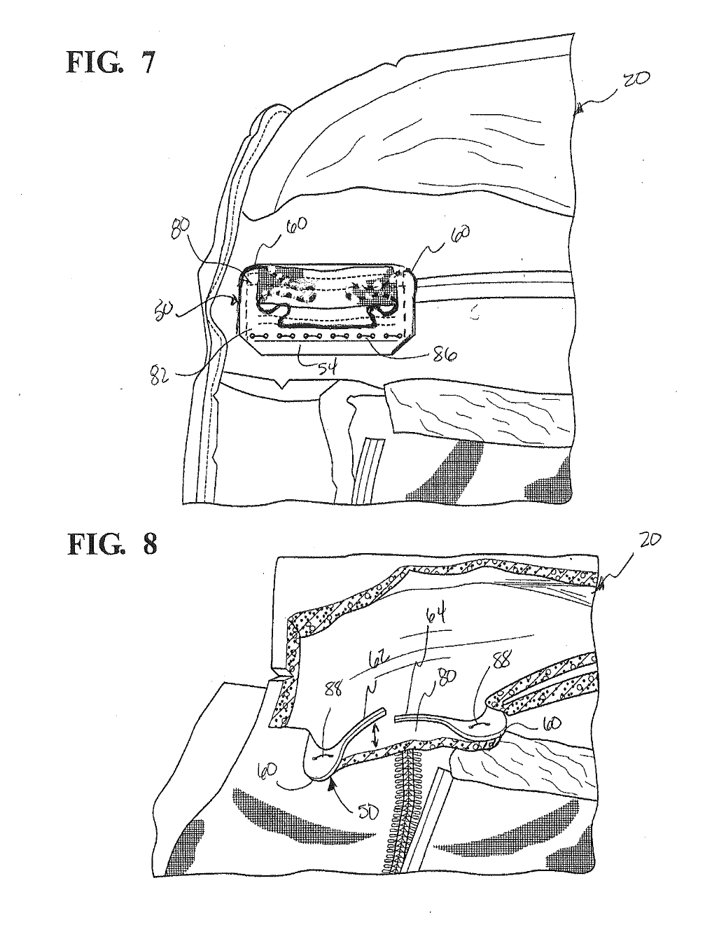

Referring to FIGS. 5, 7 and 8, the underside or back side of the trim cover 20 is shown. The trim cover 20 includes a pair of flap portions 80, 82 which and spaced apart and folded back to define the opening 24 in the trim cover 20. A scrim layer 84 is typically secured to the back side of the trim cover 20 and stitched or laminated to each of the flap portions 80, 82. The flap portions 80, 82 are folded back and lay flat against the back side of the trim cover 20 adjacent opposing sides of the opening 24 as best shown in FIG. 5. Referring to FIGS. 7 and 8, the trim retainer 50 is fixedly secured to each of the flap portions 80, 82 by thread stitches or other suitably fabric material connection method to secure the trim retainer 50 to the trim cover 22 and support the perimeter of the opening 24. More specifically, the base portion 54 is fixedly secured to the flap portion 82 by stitches 86 extending adjacent and parallel to the lower edge of the base portion 54. Additionally, stitches 88 fixedly secure each of the rounded ends 60 to the flap portion 80. Further, the base portion 54 of the trim retainer 50 is positioned or placed flat against the upper surface of the flap portion 82 spaced from the trim cover 20 and each of the elongated tabs 62, 64 are positioned along the lower surface of the flap portion 80 between the flap portion 80 and the trim cover 20. FIG. 3 illustrates the trim retainer 50 in phantom fixedly secured to the trim cover 20 and aligned with and operatively coupled to the anchor bar 22 with the anchor bar 22 projecting through the slot 72 of the trim retainer 50 and the opening 24 in the trim cover 20.

In operation, when it is desired to releasably connect and secure an ISOFIX child safety seat to the vehicle seat, the clip connectors 32 are positioned and aligned for attachment to the anchor bars 22 projecting from the openings 24 in the trim cover 20 of the vehicle seat. As each anchor bar 22 slidably enters into the notch 38, the lower portion 36 of the clip connector 32 is allowed to pass through opening 24 in the trim cover 20 and also through the slot 72 in the trim retainer 50 without pressing on the trim cover 20 or the trim retainer 50. Additionally, the upper portion 34 of the clip connector 32 presses against the trim cover 20 above the opening 24 and flexes the retention tabs 62, 64 rearwardly or inwardly with minimal effort to allow full engagement of the clip connector with the anchor bar 22. Therefore, the trim retainer 50 maintains the aesthetics and integrity of the trim cover 20 and opening 24 therein while allowing connection of the clip connector 32 with the anchor bar 22 with minimal effort by not requiring the clip connector 32 to press on, move or deform a rigid portion of the trim retainer 50 as is common with the current prior art trim retainers.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed:

1. A trim retainer for retaining an opening in a trim cover of a seat along an anchor bar adapted to be releasably connected to a clip connector, said trim retainer comprising:
a generally flat, planar body portion for encircling the opening in the trim cover; the body portion including a base portion extending between opposing side portions, a pair of retention tabs projecting inwardly towards facing distal ends and spaced generally parallel to said base portion, and an elongated slot defined between said retention tabs and said base portion adapted for receiving at least a portion of the clip connector therethrough.

2. The trim retainer as set forth in claim 1 wherein each of said side portion extends upwardly from said base portion to a rounded end adapted to be fixedly secured to said trim cover along one side of the opening therein and said retention tabs extend inwardly from said rounded ends.

3. The trim retainer as set forth in claim 2 further including a lobe projecting angularly and inwardly from each of said side portion defining opposite ends of said elongated slot with said base portion.

4. The trim retainer as set forth in claim 3 wherein each of said lobes is spaced from a respective one of said retention tab and further forms a clearance hole between said lobe and said retention tab adapted for receiving and retaining at least a portion of the anchor bar therethrough.

5. The trim retainer as set forth in claim 4 wherein said base portion is adapted to be fixedly secured to the trim cover along the opposite side of the opening therein.

6. The trim retainer as set forth in claim 5 wherein said facing distal ends of said retention tabs form a gap therebetween for allowing each of said retention tabs to flex relative to said rounded ends in a direction generally transverse to said planar body portion.
